(19) United States
(12) Patent Application Publication
(10) Pub. No.: US 2014/0044432 A1
(43) Pub. Date: Feb. 13, 2014

(54) AUDIO SIGNAL TO INFRARED CONVERSION DEVICE

(71) Applicant: Synmin Technology Co., Ltd., Taipei City (TW)

(72) Inventor: SHIH-CHUAN CHUANG, Taipei City (TW)

(73) Assignee: Synmin Technology Co., Ltd., Taipei City (TW)

(21) Appl. No.: 13/959,944

(22) Filed: Aug. 6, 2013

Related U.S. Application Data
(60) Provisional application No. 61/681,203, filed on Aug. 9, 2012.

(51) Int. Cl. G08C 23/04

(52) U.S. Cl. CPC G08C 23/04
USPC 398/111; 398/106

(57) ABSTRACT

The present invention provides an audio signal to infrared conversion device, comprising: a voltage-multiplying circuit rectifier/filter module, a waveform amplifier module, a microprocessor, an IR signal emitter module, and an IR signal receiver module. The voltage-multiplying circuit rectifier/filter module is coupled to a headset plug; the waveform amplifier module is also coupled to the headset plug, wherein the voltage-multiplying circuit rectifier/filter module is coupled to either one of a left channel connection part and a right channel connection part of the headset plug, and the waveform amplifier module is coupled to the other one of them. The microprocessor is coupled to the voltage-multiplying circuit rectifier/filter module and the waveform amplifier module. The IR signal emitter module is coupled to the microprocessor. The IR signal receiver module is coupled to the microprocessor and the IR signal emitter module.

### BACKGROUND OF THE INVENTION

1. Field of the Invention

The present invention relates to an infrared (IR) signal emitting and receiving device; more particularly, the present invention relates to an audio signal to IR signal conversion device or an IR signal to audio signal conversion device.

2. Description of the Prior Art

As technology advances nowadays, types of electrical home appliances keep increasing, and many of them feature wireless control functions. However, since each appliance has its own remote control, it is even more frequent for people to find their remote controls missing when there are so many controls in daily life. To solve this problem, universal remote controls have been developed. With a universal remote control, people can use one single remote control to operate various appliances, such as television, stereo, video recorder, set-top box, etc., even if the products are of different brands.

Although using a universal remote control is more convenient, it is still a single device that consumers need to buy separately. People cannot have the wireless control functions of a conventional universal remote control integrated into common portable wireless devices in daily life, such as mobile phones or tablet computers. Moreover, users cannot have further interaction with conventional universal remote controls through application programs. Those remote controls are usually limited to simple frequency-switching functions for controlling home appliances, and most of them are not provided with an IR learning function. The IR learning function means that a device can memorize the content and frequency of an IR signal which the device has received from an external remote control. The device can further transmit an IR signal having the same memorized content by its own IR emitter to control appliances, and therefore the original remote control is not in need.

### SUMMARY OF THE INVENTION

Given the above deficiencies of conventional universal remote controls, an object of the present invention is to provide an audio signal to IR signal conversion device, characterized in that it can be connected to any portable wireless device equipped with a headset jack, such as a mobile phone or a tablet computer, so that the portable wireless device can have universal remote control functions.

According to this object, the present invention provides an audio signal to infrared conversion device, comprising: a voltage-multiplying circuit rectifier/filter module, a waveform amplifier module, a microprocessor, an IR signal emitter module, and an IR signal receiver module. The voltage-multiplying circuit rectifier/filter module is coupled to a headset plug; the waveform amplifier module is also coupled to the headset plug, wherein the voltage-multiplying circuit rectifier/filter module is coupled to either one of a left channel connection part and a right channel connection part of the headset plug, and the waveform amplifier module is coupled to the other one of them. The microprocessor is coupled to the voltage-multiplying circuit rectifier/filter module and the waveform amplifier module. The IR signal emitter module is coupled to the microprocessor. The IR signal receiver module is coupled to the microprocessor and the IR signal emitter module.

The present invention provides an audio signal to infrared conversion device as described above, and preferably, the voltage-multiplying circuit rectifier/filter module outputs a level signal to the microprocessor to wake the microprocessor up from sleep mode to enter work mode. Further, the waveform amplifier module outputs an amplified signal to the microprocessor, which decodes the amplified signal to obtain either one of an inter-device communication command and an IR signal emission command. Further, when the microprocessor obtains the inter-device communication command, the microprocessor processes and transmits an inter-device communication signal to the headset plug. Further, when the microprocessor obtains the IR signal emission command, the microprocessor processes and transmits an IR signal emission signal to the IR signal emitter module, wherein the carrier wave of the IR signal emission signal is a square wave having a frequency being one of, but not limited to, the following: 32 KHz, 38 KHz, 36 KHz, 40 KHz and 56 KHz. Further, the the IR signal emitter module comprises an field-effect transistor and an IR light emitting diode. Further, the IR signal receiver module comprises an IR receiver head to receive an external IR signal, and the external IR signal is converted into an electric potential signal which is transmitted back to either one of the headset plug and the microprocessor.

The present invention provides an audio signal to infrared conversion device as described above, and preferably, the conversion device further comprises an external battery to supply power to the waveform amplifier module, the microprocessor, and the IR signal emitter module; or, the conversion device utilizes waves output from the headset jack as a power source to supply power to the microprocessor and the IR signal emitter module.

According to the object as described above, the present invention further provides an audio signal to infrared conversion device, comprising: a first diode, a second diode, a third diode, a fourth diode, and an IR light emitting diode. The first diode is coupled to a left channel connection part of a headset plug. The second diode is coupled to a right channel connection part of the headset plug and the first diode. The third diode is coupled to the left channel connection part of the headset plug and the first diode. The fourth diode is coupled to the right channel connection part of the headset plug, the second diode, and the third diode. The IR light emitting diode is coupled to the first diode, the second diode, the third diode, and the fourth diode.

The present invention provides an audio signal to infrared conversion device as described above, and preferably, when the first diode receives a level signal from the left channel connection part of the headset plug, the level signal goes through the first diode, the IR light emitting diode, the fourth diode to the right channel connection part of the headset plug. Further, when the second diode receives a level signal from the right channel connection part of the headset plug, the level signal goes through the second diode, the IR light emitting diode, the third diode to the left channel connection part of the headset plug.

As described above, an audio signal to infrared conversion device of this invention can be connected to a portable wireless device equipped with a headset jack, such as a mobile phone or a tablet computer. Therefore, the present invention has the following advantages: users can use their mobile phones or tablet computers to remotely control various appliances; besides, the device is provided with the IR learning function, and users need not use a separate universal remote control to control appliances. Moreover, with the audio signal to infrared conversion device of this invention, users can further control IR signals or do relevant computational processing through an application, and then save the signals to their mobile phones or tablet computers in audio signal formats.

### BRIEF DESCRIPTION OF THE DRAWINGS

FIG. 1 is a system block diagram showing a first embodiment of the present invention.

FIG. 2 is a circuit diagram of the waveform amplifier module according to the first embodiment of the present invention.

FIG. 3 is a flow chart showing the operation of the microprocessor according to the first embodiment of the present invention.

FIG. 4 is a circuit diagram showing an example of the IR signal emitter module and receiver module according to the first embodiment of the present invention.

FIG. 5 is a circuit diagram showing another example of the IR signal emitter and receiver module according to the first embodiment of the present invention.

FIG. 6 is a circuit diagram showing a second embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. Numerals mentioned in the following description refer to those shown in the drawings.

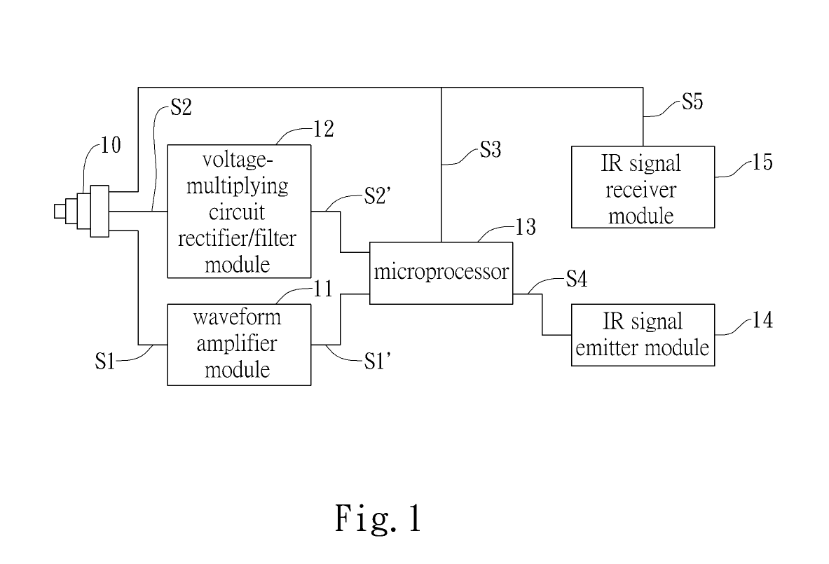

FIG. 1 is a system block diagram showing a first embodiment of the present invention. As FIG. 1 shows, a headset plug 10 is coupled to a voltage-multiplying circuit rectifier/filter module 12, a waveform amplifier module 11, and a microprocessor 13. The headset plug 10 transmits a right channel signal S2 to the voltage-multiplying circuit rectifier/filter module 12, which outputs a level signal S2′ to the microprocessor 13. The level signal S2′ acts as a signal that wakes the microprocessor 13 up from sleep mode to enter work mode. Moreover, the headset plug 10 transmits a left channel signal S1 to the waveform amplifier module 11, which amplifies the signal and outputs a left channel amplified signal S1′ to the microprocessor 13 for processing. When the microprocessor 13 receiving the left channel amplified signal S1′ is in work mode (i.e., the microprocessor 13 has detected that the level signal S2′ is of high level), it correspondingly decodes and processes the left channel amplified signal S1′. After decoding, if the microprocessor 13 finds the left channel amplified signal S1′ includes an inter-device communication command, it transmits a corresponding inter-device communication signal S3 back to the headset plug 10; the inter-device communication signal S3 is then sampled via a microphone input and transmitted to a mobile phone. Preferably, the inter-device communication signal S3 is finally received by a mobile phone application, so that communication between the mobile phone application and the microprocessor 13 is achieved. If, after decoding, the microprocessor 13 finds that the left channel amplified signal S1′ includes an IR signal emission command, it transmits an IR signal emission signal to an IR signal emitter module 14; the IR signal emitter module 14 then emits IR signals outward to remotely control a device or to realize IR communications between devices. After receiving an external IR signal, an IR signal receiver module 15 generates a corresponding electric signal S5 and transmits it to the headset plug 10; the electric signal S5 is then sampled via a microphone input and transmitted to a mobile phone. Preferably, the mobile phone can save this audio file and then analyze and process it through an application. For example, the content of a received IR signal may be duplicated, and then the duplicated signal may be emitted by the IR signal emitter in this invention to control devices, so that IR learning and universal remote functionalities are realized. The foregoing approach of duplicating and emitting IR signals may be done indirectly through a mobile phone application that gives commands. Alternatively, the microprocessor 13 may directly receive and duplicate the IR signals, and then give the IR signal emitter module 14 a command to emit the signals. In the present invention, the functions of the left channel signal S1 and the right channel signal S2 are not limited hereto. In different embodiments, the left and right channel signals S1 and S2 may be reversed according to different needs or designs. That is, for example, the left channel signal S1 is input to the voltage-multiplying circuit rectifier/filter module 12, and the right channel signal S2 is input to the waveform amplifier module 11. Moreover, if the amplitude of the waveform output from the headset jack of a mobile phone is large enough, this output can be used as a power source to drive the microprocessor 13; then, the microprocessor 13 does not need to connect to an external battery for power supply. In addition, the waveform amplifier module 11 is not in need if the amplitude of the waveform output from the headset jack is large enough. Those ordinarily skilled in the art shall understand that, without departing from the spirit and scope of this invention, the mobile phone as described above may be replaced with a tablet PC or a portable digital media player.

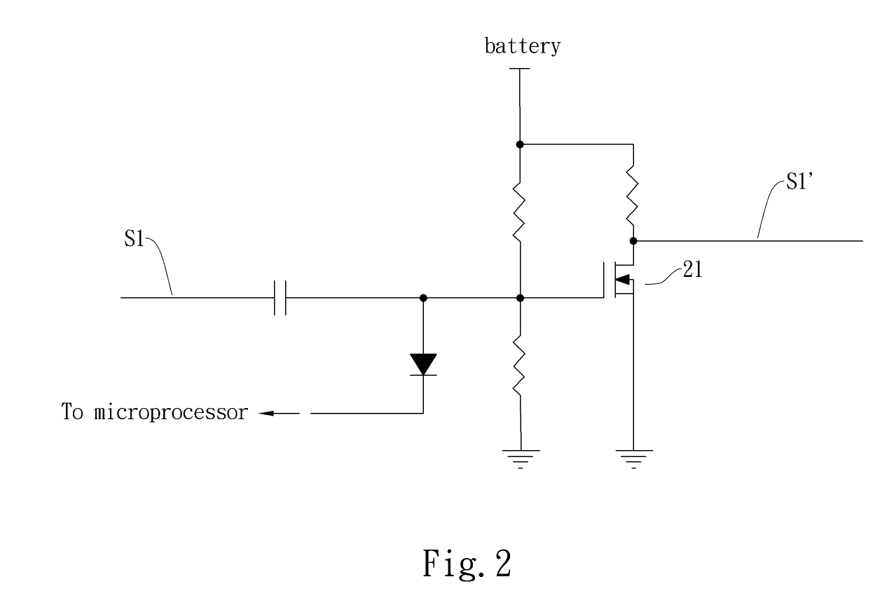

FIG. 2 is a circuit diagram of the waveform amplifier module according to a first embodiment of the present invention. As shown in FIG. 2, after the left channel signal S1 is input to the waveform amplifier module 11, a field-effect transistor (FET) 21 amplifies the left channel signal S1 and outputs a left channel amplified signal S1′ to the microprocessor 13. It should be noted that in the embodiment shown in FIG. 2, the FET 21 of the waveform amplifier module is an n-type metal-oxide-semiconductor field effect transistor (MOSFET); however, those ordinarily skilled in the art shall understand that, without departing from the spirit and scope of this invention, the FET 21 may also be a p-type MOSFET if the circuit diagram is modified accordingly. Moreover, the n-type MOSFET may be replaced with an NPN transistor, and the p-type MOSFET may be replaced with a PNP transistor.

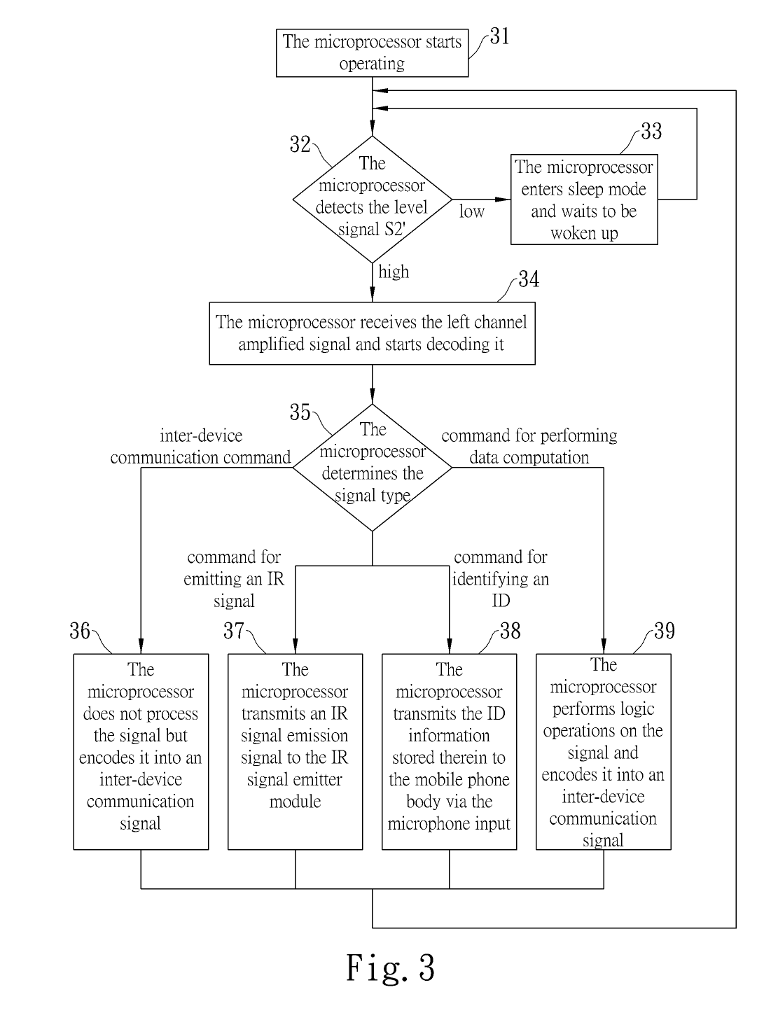

FIG. 3 is a flow chart showing the operation of the microprocessor according to the first embodiment of the present invention. As shown in FIG. 3, the operation of the microprocessor in this invention includes the following steps:

Step 31: The microprocessor starts operating.

Step 32: The microprocessor detects the level signal S2′. When the level signal S2′ is of low level, the process goes to Step 33; when it is of high level, the process goes to Step 34.

Step 33: The microprocessor enters sleep mode and waits to be woken up. Those ordinarily skilled in the art shall understand that, the microprocessor may be woken up by an external signal such as an interrupt signal or a signal from a watchdog timer.

Step 34: The microprocessor receives the left channel amplified signal and starts decoding it.

Step 35: The microprocessor determines the signal type and corresponding execution according to the decoded content of the left channel amplified signal. When the signal is an inter-device communication command which does not require processing by the microprocessor, the process goes to Step 36. When the signal is a command for emitting an IR signal, the process goes to Step 37. When the signal is a command for identifying an ID, the process goes to Step 38. When the signal is a command for performing data computation, the process goes to Step 39.

Step 36: The microprocessor does not process the signal but encodes it into an inter-device communication signal. The encoded signal is then transmitted to the mobile phone body via the microphone input.

Step 37: The microprocessor transmits an IR signal emission signal to the IR signal emitter module, wherein the carrier wave of the IR signal emission signal is a square wave that may have a frequency being one of, but not limited to, the following: 32 KHz, 38 KHz, 36 KHz, 40 KHz and 56 KHz.

Step 38: The microprocessor transmits the ID information stored therein to the mobile phone body via the microphone input.

Step 39: The microprocessor performs logic operations on the signal and encodes it into an inter-device communication signal. The encoded signal is then transmitted to the mobile phone body via the microphone input.

After any of the Steps 36, 37, 38 and 39 finishes, the process goes back to Step 32, restarting to deal with the next left channel amplified signal.

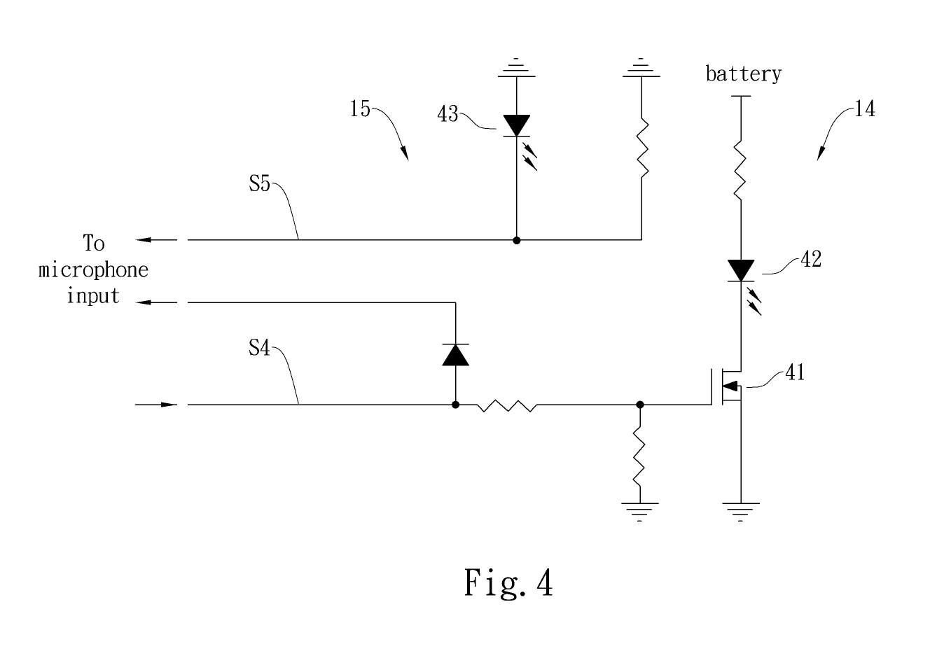

FIG. 4 is a circuit diagram showing an example of the IR signal emitter module and receiver module according to the first embodiment of the present invention. As FIG. 4 shows, after the IR signal emission signal S4 is input to the IR signal emitter module 14 and undergoes the switching of an FET 41, an IR light emitting diode 42 sends out an IR signal. That is, the IR signal emission signal S4 drives the switch of the FET 41, which further makes the IR light emitting diode 42 to emit a carrier wave of the same frequency. When the microprocessor detects that the level signal S2′ is of low level, the signal emission signal S4 also remains low level and thus cannot turn on the FET 41; consequently, the IR light emitting diode 42 will not emit light. In addition, the IR signal receiver module 15 receives an external IR signal through an IR signal receiver head 43 and converts it into an electric potential signal S5, which is then transmitted to the mobile phone via the microphone input and becomes an audio signal. Alternatively, the electric potential signal S5 may be input to the microprocessor. After processing the electric potential signal S5, the microprocessor determines whether to transmit a signal to the mobile phone or not. Preferably, the mobile phone can save this audio signal and then analyze and process the audio file through an application. It should be noted that in the embodiment shown in FIG. 4, the FET 41 of the waveform amplifier module is an n-type metal-oxide-semiconductor field effect transistor (MOSFET); however, those ordinarily skilled in the art shall understand that, without departing from the spirit and scope of this invention, the FET 41 may also be a p-type MOSFET if the circuit diagram is modified accordingly. Moreover, the n-type MOSFET may be replaced with an NPN transistor, and the p-type MOSFET may be replaced with a PNP transistor.

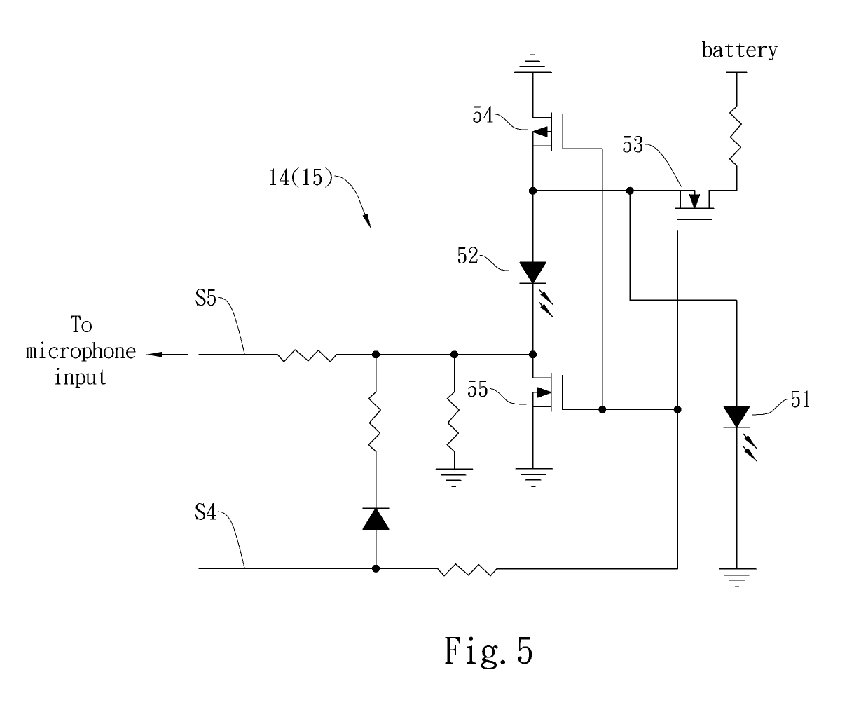

FIG. 5 is a circuit diagram showing another example of the IR signal emitter and receiver module according to the first embodiment of the present invention. Different from the example shown in FIG. 4 where the IR signal emitter module 14 and the IR signal receiver module 15 are separate units, in FIG. 5, the two modules are integrated in one design. As FIG. 5 shows, an IR signal emission signal S4 is input to the IR signal emitter module 14. The IR signal emission signal S4 drives FETs 53, 54, 55 into conduction, thereby enabling IR light emitting diodes 51, 52 to emit an IR signal respectively. More specifically, the IR signal emission signal S4 turns on each switch of the FETs 53, 54, 55, thereby making the IR light emitting diodes 51, 52 to emit carrier waves of the same frequency. This ensures that one of the IR light emitting diodes 51, 52 will still function normally if the other one malfunctions, so that IR signals can be emitted normally by the device. In addition, the IR signal receiver module 15 receives an external IR signal through an IR signal receiver head 52 and converts it into an electric potential signal S5, which is then transmitted to the mobile phone via the microphone input and becomes an audio signal. Alternatively, the electric potential signal S5 may be input to the microprocessor. After processing the electric potential signal S5, the microprocessor determines whether to transmit a signal to the mobile phone or not. Preferably, the mobile phone can save this audio signal and then analyze and process the audio file through an application. It should be noted that in the embodiment shown in FIG. 5, the FETs 53, 54, 55 of the waveform amplifier module are n-type MOSFETs; however, those ordinarily skilled in the art shall understand that, without departing from the spirit and scope of this invention, the field-effect transistors 53, 54, 55 may also be p-type MOSFETs if the circuit diagram is modified accordingly. Moreover, each n-type MOSFET may be replaced with an NPN transistor, and the p-type MOSFET may be replaced with a PNP transistor.

In the above first embodiment, generally, an external battery or power source is connected to the waveform amplifier module 11, the microprocessor 13, and the IR signal emitter module to provide stable power supply. However, an audio signal and IR signal conversion device of the present invention may also utilize waves output from the headset jack as a power source for the microprocessor 13 and the IR signal emitter module 14.

It should be noted that in the first embodiment described above, the voltage-multiplying circuit rectifier/filter module 12 is coupled to the right channel connection part of the headset plug, and the waveform amplifier module 11 is coupled to the left channel connection part of the headset plug. However, those ordinarily skilled in the art shall understand that, without departing from the spirit and scope of this invention, the voltage-multiplying circuit rectifier/filter module 12 may be coupled to the left channel connection part of the headset plug, and the waveform amplifier module 11 may be coupled to the right channel connection part of the headset plug. The different left and right connection methods only bring about different definitions of the signals transmitted from left/right channels; the different embodiments shall not be interpreted in a limiting sense and have no influence on the effects of the present invention.

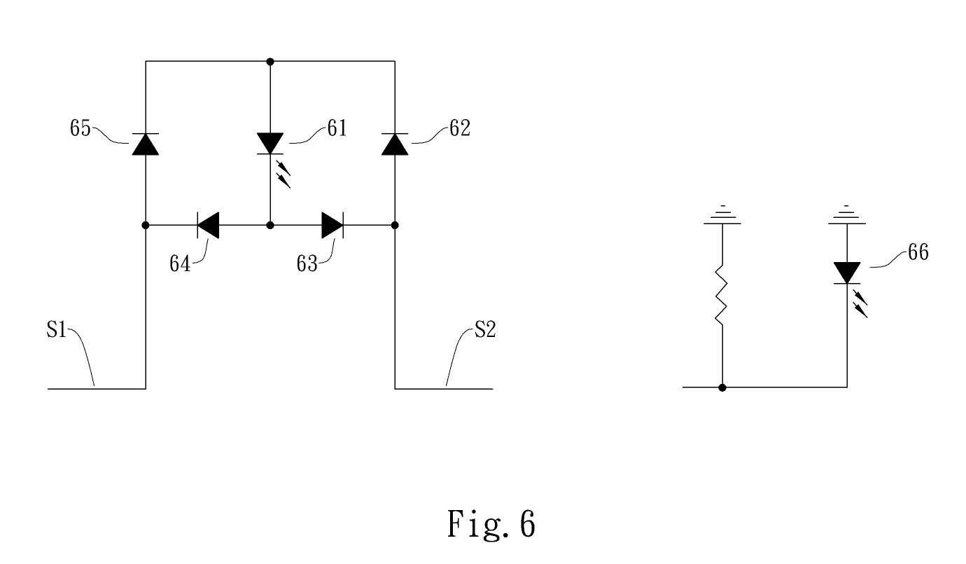

FIG. 6 is a circuit diagram of a second embodiment of the present invention. As FIG. 6 shows, an audio signal and IR signal conversion device of the present invention is connected to a headset jack of a mobile phone. The device uses the left channel signal S1 and the right channel signal S2, sent out as positive and negative signals alternately, to generate a maximum voltage difference, which, after the rectification of a diode, enables an IR light emitting diode 61 to emit light. The basic operating mechanism of this embodiment is as follows: When the left channel signal S1 is of high level and the right channel signal S2 is of low level, the current goes from the left channel through a diode 65, the IR light emitting diode 61, a diode 63 to the right channel, thereby driving the IR light emitting diode 61 to emit light. When the right channel signal S2 is of high level and the left channel signal S1 is of low level, the current goes from the right channel through a diode 62, the IR light emitting diode 61, a diode 64 to the left channel, thereby driving the IR light emitting diode 61 to emit light. Moreover, to allow the IR light emitting diode 61 to generate an IR carrier wave having a frequency F, a wave of the frequency F/2 can be set to be output from the left channel while a wave of the frequency F/2 but opposite in phase to be output from the right channel. In this manner, the waves going through the circuit of this embodiment will enable the IR light emitting diode 61 to generate an IR carrier wave of a frequency F. Moreover, an IR receiver head 66 receives IR signals transmitted by external devices. When the IR receiver head 66 senses an IR signal, it generates an electric signal. The electric signal is then sampled via the microphone input and transmitted to the device of this invention as an audio signal. The mobile phone saves this audio signal into an audio file, which can be saved, analyzed, and processed by an application. The second embodiment can realize audio signal and IR signal conversions with a lower cost than the first embodiment; besides, an external battery or power source is not required in the second embodiment.

To sum up, with an audio signal to infrared conversion device of this invention, conversions between audio signals and IR signals can be achieved simply by connecting the device to the headset jack of a mobile phone. The conversion operation includes converting audio signals to IR signals for controlling external devices. The conversion operation also includes converting IR signals received from external devices to audio signals and then analyzing, processing and saving the signals to a mobile phone through an application. In other words, an audio signal to infrared conversion device of this invention is provided with the IR learning function. Through the microprocessor of the conversion device or a mobile phone application, an IR signal received from external devices may be duplicated and processed to generate another corresponding IR signal, which can be used to control or communicate with external devices, so that the function of a universal remote control is realized. Moreover, as described in the first embodiment of this invention, through the selection made by a microprocessor, the audio signal to infrared conversion device can further output carrier waves at various desired frequencies in the form of square wave.

The embodiments depicted above and the appended drawings are exemplary and are not intended to limit the scope of the present invention. Any change or alteration with equivalent efficiency made without departing from the spirit and scope of this invention fall within the scope of the appended claims.

What is claimed is:

1. An audio signal to infrared conversion device, comprising:
a voltage-multiplying circuit rectifier/filter module coupled to a headset plug;
a waveform amplifier module coupled to the headset plug, wherein the voltage-multiplying circuit rectifier/filter module is coupled to either one of a left channel connection part and a right channel connection part of the headset plug, and the waveform amplifier module is coupled to the other one of them;
a microprocessor coupled to the voltage-multiplying circuit rectifier/filter module and the waveform amplifier module;
an IR signal emitter module coupled to the microprocessor; and
an IR signal receiver module coupled to the microprocessor and the IR signal emitter module.

2. The audio signal to infrared conversion device of claim 1, wherein the voltage-multiplying circuit rectifier/filter module outputs a level signal to the microprocessor to wake the microprocessor up from sleep mode to enter work mode.

3. The audio signal to infrared conversion device of claim 1, wherein the waveform amplifier module outputs an amplified signal to the microprocessor, which decodes the amplified signal to obtain either one of an inter-device communication command and an IR signal emission command.

4. The audio signal to infrared conversion device of claim 3, wherein when the microprocessor obtains the inter-device communication command, the microprocessor processes and transmits an inter-device communication signal to the headset plug.

5. The audio signal to infrared conversion device of claim 3, wherein when the microprocessor obtains the IR signal emission command, the microprocessor processes and transmits an IR signal emission signal to the IR signal emitter module.

6. The audio signal to infrared conversion device of claim 5, wherein a carrier wave of the IR signal emission signal is a square wave having a frequency being one of, but not limited to, the following: 32 KHz, 38 KHz, 36 KHz, 40 KHz and 56 KHz.

7. The audio signal to infrared conversion device of claim 1, wherein the IR signal emitter module comprises a field-effect transistor and an IR light emitting diode.

8. The audio signal to infrared conversion device of claim 1, wherein the IR signal receiver module comprises an IR receiver head to receive an external IR signal, and the external IR signal is converted into an electric potential signal which is transmitted back to either one of the headset plug and the microprocessor.

9. The audio signal to infrared conversion device of claim 1, further comprising an external battery to supply power to the waveform amplifier module, the microprocessor, and the IR signal emitter module.

10. The audio signal to infrared conversion device of claim 1, which uses output from the headset plug as a power source to supply power to the microprocessor and the IR signal emitter module.

11. An audio signal to infrared conversion device, comprising:
a first diode coupled to a left channel connection part of a headset plug;
a second diode coupled to a right channel connection part of the headset plug and the first diode;
a third diode coupled to the left channel connection part of the headset plug and the first diode;
a fourth diode coupled to the right channel connection part of the headset plug, the second diode, and the third diode; and
an IR light emitting diode coupled to the first diode, the second diode, the third diode, and the fourth diode.

12. The audio signal to infrared conversion device of claim 11, wherein when the first diode receives a level signal from the left channel connection part of the headset plug, the level signal goes through the first diode, the IR light emitting diode, the fourth diode to the right channel connection part of the headset plug.

13. The audio signal to infrared conversion device of claim 11, wherein when the second diode receives a level signal from the right channel connection part of the headset plug, the level signal goes through the second diode, the IR light emitting diode, the third diode to the left channel connection part of the headset plug.
